(19) United States
(12) Patent Application Publication
(10) Pub. No.: US 2010/0030181 A1
(43) Pub. Date: Feb. 4, 2010

(54) DUAL-LUMEN NEEDLE

(76) Inventors: Kevin Helle, Bartlett, IL (US); Jay Reed, Elk Grove Village, IL (US)

Correspondence Address: GE HEALTHCARE, INC., IP DEPARTMENT 101 CARNEGIE CENTER, PRINCETON, NJ, 08540-6231, US

(21) Appl. No.: 12/515,557

(22) PCT Filed: Nov. 30, 2007
(86) PCT No.: PCT/US07/86006

§ 371 Date: May 20, 2009

Related U.S. Application Data
(60) Provisional application No. 60/867,926, filed on Nov. 30, 2006.

(51) Int. Cl. A61J 1/20

(52) U.S. Cl. 604/411

(57) ABSTRACT

A dual-lumen needle for aseptic filling and withdrawal of fluids from septum-plugged containers

### FIELD OF THE INVENTION

The present invention is directed to the field of radiopharmaceutical handling equipment. More specifically, the present invention relates to a dual-lumen needle which allows the sterile transfer of pharmaceutical fluids.

### BACKGROUND OF THE INVENTION

A basic premise for the manufacture and handling of pharmaceutical fluids is the use of aseptic techniques. The pharmaceutical fluids are typically held within a container having a pierceable septum. The containers typically include a pharmaceutical type I glass bottle, a polymeric re-sealing septum, and an aluminum seal crimped onto the neck of the bottle and over the septum. These containers, depending on their function in the delivery chain of the pharmaceutical, are either meant to be filled with the pharmaceutical fluids or to supply the pharmaceutical fluid to another container or syringe or the like. Typically the components are cleaned and sterilized, then aseptically assembled, whereby the fluid is added to the bottle, the septa is inserted on the bottle, then the septa is capped and sealed with an aluminum seal. Alternatively, the components may be cleaned and sterilized, aseptically assembled with the drug product, and then the entire finished unit is terminally sterilized.

Whether the particular operation requires the pharmaceutical to be withdrawn from or added to the container, the art employs two needles for piercing the septum of the container. One needle is used for conducting the pharmaceutical into or out of the container. The other needle is used to either vent the container, ie, to allow the gas within the container to escape during filling, or to allow gas into the container to replace the void volumes created as the fluid is withdrawn and to prevent overpressure of the filled container. For example, sterile saline is often removed from one container to reconstitute freeze-dried pharmaceutical product in another container. Another example is Technetium-99m is removed from one pharmaceutical container to reconstitute freeze-dried pharmaceutical product in another container. It is highly desirable that these pharmacy operations be performed aseptically.

Placement of two needles through the septum is difficult and fraught with risks to the pharmaceutical product and to the people handling it. One of the needles may be improperly positioned such that it hits the aluminum crimp, damaging both the crimp and/or the needle and causing a unit failure. If the open ends of the two needles are positioned in too close proximity to each other, liquid could transfer from one needle to the other and, especially when transferring a radiopharmaceutical fluid, cause a radioactive contamination event outside of the container and on or near personnel.

Additionally, should the septum core into the vent needle, thereby blocking it, can cause undetected overpressure in the filled container as the vent needle does not allow gas in the container to escape during filling. The overpressure may cause the contents to spray out onto the pharmacist when drawing patient doses from the container. Such problems also complicate the automation of such processes whereby additional handling equipment is required to precisely insert both needles through a septum.

The art has seen devices which could puncture a septum and provide both a fill path and a venting path, however, each of these devices cannot provide for aseptic fluid transfer whereby the septum integrity is retained after the fluid transfer operation.

For example, U.S. Pat. No. 7,091,494, which is commonly owned by the assignee of the instant invention, describes a dual-lumen spike for puncturing the septum of a container holding a radiopharmaceutical. The spike provides a first lumen for conducting fluid from the septum and a second lumen for venting the container. However, the large bore of a spike does not maintain the integrity of the septum after it has been withdrawn therefrom. The radiopharmaceutical remaining in the container would therefore be exposed to the outer environment.

Millipore Corporation manufactures and sells a dual needle concept under the tradename Sterisolutest. This product is used to remove finished pharmaceutical product from vials for sterility testing. Millipore has added a plastic fluid path for liquid transfer over the large bore needle, resulting in a very large bore requiring greater pressure and significant deformation of the septum in order to accomplish the fluid transfer. While it may be used in an aseptic operation, this device destroys the septum integrity such that the container would lose its hermetic seal at the conclusion of the process, thereby exposing the contents of the container to the outer environment.

Baxa manufactures a needle which provides venting by including plastic hub having radially-projecting fins extending annularly about the needle. Venting is accomplished by pushing the needle hub all the way into the septum such that the hub wings penetrate and further spread open the septum, allowing gas to travel through the grooves between the wings in the plastic hub. However, this design destroys the re-sealing of thin septums while thick septums are able to fill in around the wings and thereby prevent venting. Moreover, this is neither an aseptic operation, nor does it allow for verification of bacterial retention testing.

Wallace manufactures an oocyte recovery system using a dual lumen needle. One lumen is used to deliver a solution for internal lavage of the uterus. The other lumen is used to aspirate the solution in the recovery of oocytes. The needle is either 16 or 17 gauge and is 30-33 centimeters long. It includes 1 centimeter of echomarking at its free end. The length and construction of this needle preclude its use in aseptic filling operations, especially when conducting radiopharmaceuticals as there would be too much radioactive product retained within the needle itself.

The art would therefore benefit from a single needle which could both conduct fluid and vent the container in a manner that maintains the integrity of the septum of the container. The single needle would allow for aseptic filling and withdrawal of fluid into or out of the container. Such a needle would allow for the aseptic and terminal sterilization manufacture of pharmaceutical drug products into pre-sterilized, pre-sealed bottles. If purchased from a supplier, such a needle would eliminate the need for significant facility infrastructure, maintenance and monitoring, and validation of major systems in pharmaceutical plants, such as clean steam, water for injection, water for injection distribution systems, oil free compressed air, and facility clean-room HVAC.

### SUMMARY OF THE INVENTION

In view of the needs of the prior art, the present invention provides a dual-lumen needle which is capable of being inserted through the septum of a container plug to provide fluid transfer either into or out of the container while maintaining septum integrity after the fluid transfer operation and the needle is withdrawn from the septum.

Additionally, the present invention allows for a filter media to be placed in line with a vent passageway of the dual-lumen needle. By providing the filter separately, the present invention allows for unique testing for bubble-point or pore size verification so as to establish an asceptic fill using the dual-lumen needle.

### BRIEF DESCRIPTION OF THE DRAWINGS

FIG. 1 depicts a cross-sectional view of a dual-lumen needle of the present invention inserted through the septum of a container.

FIG. 2 depicts an alternate embodiment a dual-lumen needle of the present invention.

FIG. 3 depicts an alternate embodiment of the tapered needle ends of a dual-lumen needle of the present invention.

### DETAILED DESCRIPTION OF THE PREFERRED EMBODIMENT

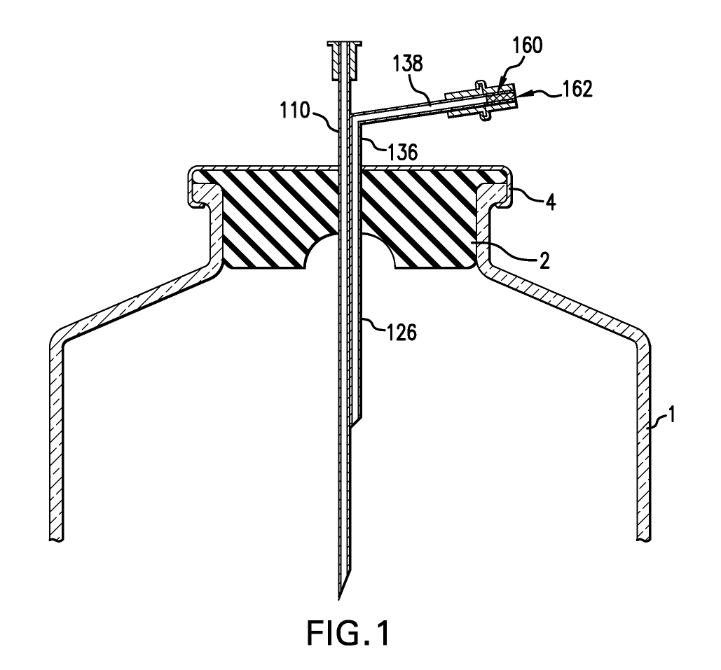

With reference to FIG. 1, the present invention provides a dual-lumen needle 110. Employing a tube-along-a-tube design, needle 110 allows the transfer of fluid into a container 1 having penetrable self-resealing septum 2 and a foil seal 4 using only a single needle penetration. Additionally, a small-bore, single penetration, will still leave a hermetically sealed container following the filling process. The present invention thus provides a single needle puncture during trans-septal fluid transfer. The needle is desirably fitted with modified luer lock hubs to allow for easy establishment and separation of the fluid and gas paths.

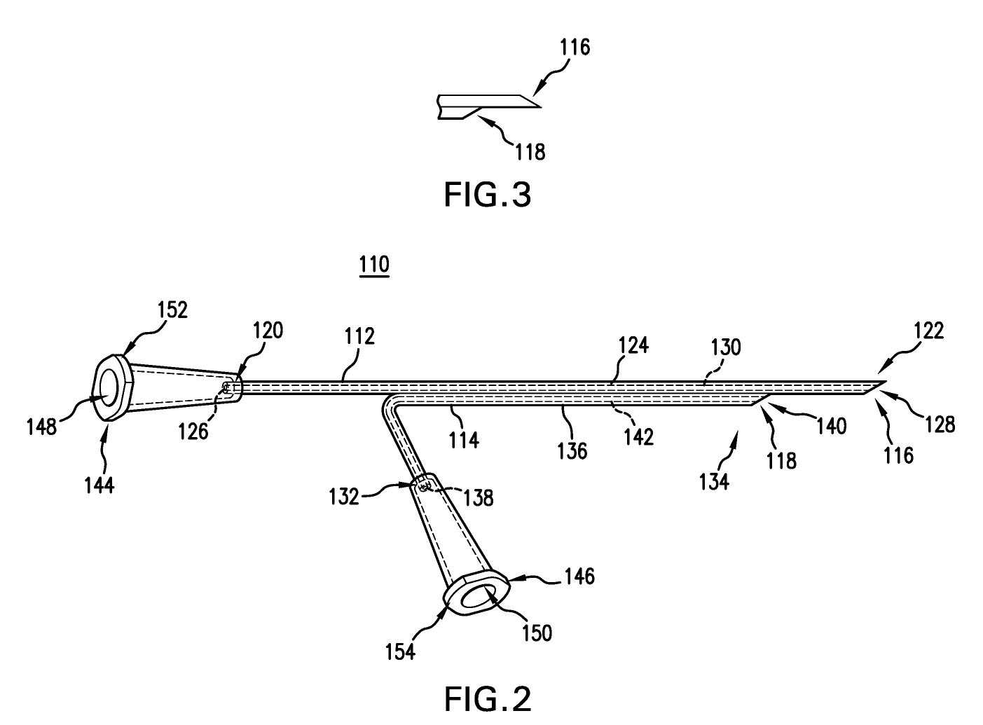

FIG. 2 depicts a dual-lumen needle 110 of the present invention, whereby two needle bodies, 112 and 114, are longitudinally-connected to each other such that their beveled tips, 116 and 118, respectively, are aligned. The term ‘aligned’ is used to describe the fact that the two needles will make one needle puncture. Beveled tip 118 of the second needle body 114 is obliquely-oriented away from the longitudinal axis of needle body 112. Thus, it is contemplated by the present invention that beveled tips 116 and 118 are oriented either in the same direction, as shown in FIGS. 1 and 2, or symmetrically away from the longitudinal axis of needle 110, as shown in detail in FIG. 3.

Needle bodies 112 and 114 are desirably formed from stainless steel and may be nickel plated or plated with other metals based upon drug compatibility, although any medical-grade or pharmaceutical-compatible material may be used. Needle body 112 has a first end 120, a second end 122 including beveled tip 116, and an elongate tubular body 124 extending therebetween. First end 120 defines a fluid port 126, beveled tip 116 defines a dispense port 128, and tubular body 124 defines an elongate first passageway 130 extending in fluid communication therebetween. Needle body 114 has a first end 132, a second end 134 including beveled tip 118, and an elongate tubular body 136 extending therebetween. First end 132 defines a fluid port, 138, beveled tip 118 defines a dispense port 140, and tubular body 136 defines an elongate first passageway 142 extending in fluid communication therebetween. Desirably, needle 110 includes a first luer hub 144 supported on the first end of 120 of needle body 112 and a second luer hub 146 supported on the first end 132 of needle body 114. Luer hubs 144 and 146 each define an elongate passageway 148 and 150, respectively, extending in fluid communication with passageways 130 and 142, respectively. Luer hubs 144 and 146 each include luer lugs 152 and 154 respectively projecting therefrom. It is further contemplated that either of passageways 130, 142, 148, or 150 may be spanned by a filtration media as described hereinabove.

During operation needle 110 typically provides a liquid through first needle body 112 as it extends further into a container than second needle body 114. It is desirable during either the delivery or removal of a liquid there is no instance where the gas flow path is submerged in the liquid being delivered or removed. This assumes most operations will bring needle 110 in a downward direction into a container. However, in instances where needle 110 is directed in an upwards direction through a pierceable septum into a container, it may be desirable to deliver or remove fluid though the now-lower second needle body 114. It is contemplated that one or ordinary skill of the art will recognize that in such applications it would be desirable to provide a gas filtration media to span across the one of the two conduits having the higher elevation entry or exit port.

As shown in FIG. 1, a filtration media 160 defining a gas passageway 162 therethrough may be provided within or attached to second hub passageway 146. Gas passageway 162 of filtration media 160 may be provided in fluid communication with passageway 138 of second lumen 126 so as to allow gas to flow therepast but not liquid. The present invention contemplates that the filtration media may be provided within, or separately removably attachable to, luer adaptor 154 so as to allow connection to conduit supporting filtration media providing finer particulate or bacterial separation.

Beveled tip 116 may be conventionally or otherwise shaped to provide for ease of septum penetration in a manner that will allow the septum to sealingly engage tubular bodies 124 and 136 during fluid transfer and to then re-seal upon withdrawal of needle 110 and thereby maintain the sterility of the contents of the container which the septum seals. One penetration in a single manipulation maximizes the likelihood of success for aseptic transfers. Alternatively, the needle tip may be blunt-shaped or provide a transversely-opening flow port 128. The particular tip design may be selected so as to maximize the number of penetrations achievable by needle 110 prior to requiring replacement. Vent port 140 is desirably provided to be longitudinally-spaced from flow port 122 so as to allow avoid the necessity of mixing between the gas flowing passageway 142 and fluid flowing through passageway 130.

Lumens 112 and 114 are desirably made from standard 316L stainless steel and may be nickel plated or plated with other metals based upon drug compatibility. Lumen 112 may be 17 gauge or smaller and desirably 16 gauge or smaller. Lumen 114 may be of identical materials as the primary lumen. Alternatively, the lumen 114 may be constructed of a biologically compatible plastic polymer. If lumen 114 is manufactured from a plastic polymer, it is possible to manufacture or mold each lumen and its associated hub concurrently. It is contemplated that the secondary tube has a cross-sectional area that is smaller than the cross-sectional area of the primary lumen, although it is also contemplated that each tube may have the same outer diameter. Second lumen 114 is a desirably a smaller diameter tube than first lumen 112, and is contemplated to have a cross-sectional area approximately 33% to 50% of first lumen 112, and does not extend beyond the needle tip 160 and provides for gas transfer.

Needle hubs 144 and 146 may be constructed of similar materials as currently utilized by needle manufacturers. The hub material should not leach into the pharmaceutical formulation or shed particulate. Making the retentive filter media 160 separately attachable to hub 140 allows for off-line integrity test verification of filter pore size prior to using the needle of the present invention. Lumen 112 may be attached to the hub in a similar manner as needles are presently attached. It is desirable to increase the distance between the primary needle connection point and the luer fitting in order to accommodate the exit of the secondary lumen.

As it is possible for fluid to enter second lumen 114 during fluid transfer through first lumen 112, it may be desirable to increase the diameter of gas flow path either at lumen 114, hub passageway 150, or at some section along its length prior to filtration media 160. Alternatively, the filter may be incorporated into the second end of the secondary lumen nearer the vent aperture so as to prevent liquid flow too far into passageway 142.

A hydrophobic filter is utilized for gas venting such that gases can pass through, but are not wetted by aqueous solutions. The hydrophobic filter may be molded into the needle hub and act as a sterile gas vent. Alternatively, the hydrophobic filter may be attached to the terminal end of the gas vent tube. Alternatively still, the hydrophobic filter may be located some distance away affixed to flexible tubing attached to the needle hub. Non-aqueous solutions such as oils and alcohols may, conversely, utilize a similar design but with a hydrophilic filter as a vent. The filter desirably has a pore size that is bacterial retentive, such as 0.22 micron or 0.45 micron. Desirably, a common fitting such as a luer lock terminates the flexible tubing to allow for the attachment of a filter, either hydrophobic or hydrophilic as required.

While the particular embodiment of the present invention has been shown and described, it will be obvious to those skilled in the art that changes and modifications may be made without departing from the teachings of the invention. The matter set forth in the foregoing description and accompanying drawings is offered by way of illustration only and not as a limitation. The actual scope of the invention is intended to be defined in the following claims when viewed in their proper perspective based on the prior art.

What is claimed is:

1. A dual-lumen needle comprising:
a first elongate lumen comprising opposed first and second ends and an elongate first tubular body extending therebetween, said first tubular body defining an elongate passageway in fluid communication with said first and second open ends of said first lumen, wherein said second open end of said first lumen defines a flow port; and
a second elongate lumen comprising opposed first and second ends and an elongate second tubular body extending therebetween, said second tubular body defining an elongate passageway in fluid communication with said first and second open ends of said second lumen, wherein at least a portion of said second lumen extends along said first lumen and said second open end of said second lumen defines a vent port.

2. A dual-lumen needle of claim 1, further comprising filtration media defining a gas passageway therethrough, said gas passageway in fluid communication with said second passageway of said second lumen.

3. A dual-lumen needle of claim 1, wherein said filtration media extends across said second passageway of said second lumen.

4. A dual-lumen needle of claim 1, wherein said filtration media extends across said second passageway of said second lumen adjacent to one of said first and second ends of said second lumen.

5. A dual-lumen needle of claim 1, wherein said filtration media is removable from said second lumen.

6. A dual-lumen needle of claim 1, wherein said vent port is located adjacent to said flow port of said first lumen.

7. A dual-lumen needle of claim 1, wherein said vent port is longitudinally-spaced from said flow port.

8. A dual-lumen needle of claim 1, wherein said flow port and said vent port are each defined by a corresponding beveled tip, said beveled tips being aligned to provide a single puncture of a septum into which the needle is inserted.

9. A dual-lumen needle of claim 1, wherein said first lumen has a cross-sectional dimension of a 16 gauge needle.

10. A dual-lumen needle of claim 1, wherein said first lumen has a cross-sectional dimension less than a 16 gauge needle.

11. A dual-lumen needle of claim 1, wherein said flow port opens in a direction substantially transverse to the longitudinal axis of said first tubular body.

12. A dual-lumen needle of claim 1, wherein said flow port is axially-aligned with the longitudinal axis of said first tubular body.

13. A dual-lumen needle of claim 1, wherein said first end of said first lumen supports a hub having a luer fitting thereon.

14. A dual-lumen needle of claim 1, wherein said first end of said second lumen supports a hub having a luer fitting thereon.
